(19) United States
(12) Patent Application Publication
(10) Pub. No.: US 2005/0277447 A1
(43) Pub. Date: Dec. 15, 2005

(54) Mobile hand-held device

(76) Inventors: Vincentius Paulus Buil, Eindhoven (NL); Tatiana A. Lashina, Eindhoven (NL); Gerrit Hollemans, Eindhoven (NL); Fabio Vignoli, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/513,050

(22) PCT Filed: Apr. 3, 2003
(86) PCT No.: PCT/IB03/01379

§ 371 Date: Oct. 29, 2004

(30) Foreign Application Priority Data
May 3, 2002 (EP) 02076740.6

(51) Int. Cl. H04M 1/00

(52) U.S. Cl. 455/575.1

(57) ABSTRACT

A mobile hand held device (1) comprises IR motion detectors (8,9). The motion detection enables to detect whether the someone is present, and take an action, e.g. to adapt the timing of presenting events to this detected presence. The motion detection system comprises two preferably 180 degrees infrared motion detection elements (8,9) placed opposite to each other to detect together movement (preferably in 360 degrees) around the device. Preferably the IR detectors are placed at the top (6) and bottom (7) surface of the device. This configuration leavesroom for other sensors, such as touch sensors (10), on the side(s) (4,5) of the device.

The invention relates to a mobile hand-held device. Such devices are for instance mobile phones, PDA's (personal digital assistants), remote controls etc

Such devices are widely used. Many of these devices have functionality to notify the user about certain events, such as incoming phone calls, appointments, or TV programs that are about to start. Such notifications are hereinafter called “notification” or “event” without being restricted to any particular notification or event.

A problem arises when an event needs to be communicated to the user while the user is not around at the time of the event. Usually a signal is given, which stops after a certain time period. Keeping the signal on for prolonged periods of time increases the chance that the user notes the signal, but with the risk of depleting the batteries of the devices. Repeating the signal with certain time intervals (e.g. 15 min) increases the chance that the user notes the signal, but the chance remains that the user is there between signals, and absent again exactly when the signal goes off. All together, these methods are little efficient.

The present invention aims to resolve or at least reduce the cited problems.

To this end the mobile hand-held device in accordance with the invention is characterized in that the hand-held device is formed as a box, having a front and a back surface, two side surfaces, and a top and a bottom surface, and at least one surface is provided with a first infrared motion detector for detecting the presence of a person, arranged to image around the hand-held device, and means for taking an action are comprised when presence of a person is detected. By using IR motion detectors, the detection of persons is more reliable than when just the presence of heat corresponding to a person is detected, since e.g. an appliance getting hot is usually not moving. The motion detectors for detecting motion in the environment of the hand-held device should not be confused with motion sensors for detecting the own motion of the hand-held device, such as e.g. being picked up. The passive IR motion detectors should also not be confused with proximity sensors such as e.g. reflected IR time of flight distance measurement sensors, or IR parallax imaging sensors. Preferably the motion detector images 360 degrees around itself so that all motion can be detected, although the device can work also with smaller surveillance angles.

The description “box”, is not, within the concept of the invention, to be seen as to be a restrictive term, i.e. not be seen as to describe a specific or specialized shape, but merely to describe in general terms the conventional shape of such devices as mobile phones, PDA's and remote controls, which have in general a shape resembling a longitudinal block, i.e. having a longitudinal direction, a rather large and long front and back surface (the top surface often provided with buttons), two side surfaces (of substantially the same length as the bottom and top surface) and finally a top and a bottom surface. E.g. in case the device is cylindrical, with a front and back surface and a cylindrical side surface, top part of the cylindrical surface should be read in place of top surface, the top part being characterized as that part of the elliptical surface falling within prescribed angles, etc.

The invention is based on the insight that needless depletion of energy can be avoided, only when the presence of a person is detected (by the IR motion detectors) action is undertaken.

The risk of depleting the batteries is decreased. E.g. a domed lens and array of IR sensors can be put on the front surface of the device.

However a more practical embodiment is characterized in that a second infrared motion detector is present, the two motion detectors being positioned on the hand-held device to detect the presence of a person in substantially complementary parts of the 360 degrees around the hand-held device. The two motion detectors can be positioned on the opposite side surfaces, but even more preferably, they are positioned on the top and bottom surface. If the device is put on its back—as it typically will be when not used—the first detector can then image the region in front up to e.g. 90 degrees to the left and right, and similarly the other detector can image the back region. There is no blocking of part of the imaged region by the device itself. Moreover, instead of imaging just a horizontal band around the device, the motion detectors may be arranged to image also a part below or above the device, e.g. both are imaging half a sphere around the device. This is useful when the device is placed on top of a cupboard e.g., and persons are moving below the device. Lastly the configuration with motion detectors on the top and bottom surface is elegant, since it leaves room for e.g. other sensors—e.g. touch sensors—on the side surfaces, and e.g. only data input and output functions—e.g. alphanumerical buttons and a display screen—on the front surface. The back surface can then be unused, or it may contain e.g. a light detection sensor or pressure sensor indicating that the device is lying on its back.

In summary, the position of the IR detectors and the range of angles covered by the IR detectors is based on the insight that devices having such a shape are often left on a table, mantelpiece or other flat surface lying on their back. Providing two oppositely arranged IR detectors at the top and bottom surface or at the side surfaces allows a very large coverage of the space surrounding the device.

Within the concept of the invention many types of action may be undertaken, examples are:
Logging the presence of a person (this may e.g. be done by logging the presence electronically).
Sending a (non) availability message to a contacting person or entity (e.g. computer). An often encountered problem is that a contacting person tries to contact a receiving person, e.g. by telephone the receiving person is not there. Sometimes it takes several tries to get the receiving person at the telephone. He may always arrive too late in the room or may not be at home at all. The net result is frustrating for both parties. However, when, upon detecting the presence of the receiving person or another person in the room at the receiving side, a notification is sent to the contacting person or entity needlessly trying to make contact is avoided. The other person or entity can then make a telephone call or send a message to that person knowing that there is in fact someone near the mobile device. This is e.g. useful when a personal telephone call has to be made. The means of automatic redial of the last number present in a mobile phone may be activated upon detection of a presence, or an indication of presence may be sent to the contacting side, e.g. initiating a pop up message on the contacter's mobile phone or computer.
Establishing automatic telephone contact between two telephones if and when at both telephones the presence of a person is detected. In such an embodiment the telephones would start ringing at both sides when at both sides the presence of a person is detected. This embodiment is e.g. especially useful when two persons, both often not being where they are supposed to be (away from the office), try to reach each other by telephone for a personal conversation. Now that they are simultaneously present, all pending issues may be discussed.
Relaying the message to another device, e.g. a second phone in another room in which the user is present (e.g. the mobile phone of the receiver may be in the bedroom, but a DECT in house portable phone in the living room may detect the presence of the user). For this applications interappliance information transfer means may be present, such as a home network. Alternatively the contacting site may contact different devices at the receiver's side one by one.

In a preferred embodiment the device has means for checking whether or not there has been or is an event to be notified, and if so, giving an alert signal to alert the attention of the person present when presence of a person is detected.

This embodiment is based on the insight that by sounding the alarm, i.e. alerting attention of a person present, only when
a person is present and
a message or alarm has been given, i.e. if the attention of a user is needed very efficient use of available energy is made. The risk of depleting the batteries is decreased, while the chance of reaching the user is increased.

Preferably the IR detectors are provided at the top and bottom surface of the device. This arrangement makes uses most efficiently the space available for providing the IR detectors.

Preferably the top and bottom surfaces are curved, wherein the IR detector outer windows follow the curvature. Such a curved lens for the motion detector is easy to make. The front, back and side surfaces will protrude with a shape following the front resp. back surface of the lens of the front resp. back motion detector, thereby supporting the lens and hence providing stability, and furthermore giving the device a smoother appearance.

The same feature at the side surface of the device would tend to give the side surfaces a bulged appearance, reducing ease of handling of the device, which is usually picked up at the side surfaces.

Preferably the device is provided with at least one touch sensor, e.g. at a side surface of the device. Touch sensors can be of different types and indicate that the device is being handled, hence the notification event is probably taken care of. The attention of the user may alternatively be conveyed to the device by the user pushing a button.

When the touch sensor e.g. indicates that the device is picked up, the alarm or signal may be ended, and if such is the case the message may be provided. Preferably the devices comprises touch sensors at both side surfaces of the device.

The signals sounded by the device when presence of a person is detected may e.g. be auditory and/or visual.

Preferably, the device comprises means to end the alert signal after a set time period, if, upon detection of the presence of a user, the device is not picked up or activated and to reactivate the alert signal after an inactive time interval if at that time presence of a person is detected. A user may be present, but he may not be interested since it is not his mobile phone e.g. It is useless to keep sounding the alarm since the batteries will deplete. So after e.g. three seconds, the device becomes silent for e.g. 10 seconds. Then if a person is still present, the device sounds the alarm for another three seconds. This strategy is also advantageous in the case of a false alarm, such as e.g. the presence of a large dog.

Preferably the device comprises means repeat the sequence of ending the alert signal and reactivation after the inactive time interval for a set number of times, followed by a non-reactive time period. After e.g. repeating the above described strategy ten times, it may be obvious that whomever is present in the room is not going to react. So to save the battery and to avoid annoying the person present, the device stops alerting. A multiscale approach may also be used, e.g. after half an hour non-reactive time the sequence may start again.

Preferably, the means to repeat the sequence of ending the alert signal and reactivation for a set number of times, are arranged to employ inactive time intervals of increasing duration. E.g. the alarm is sounded for three seconds, then three seconds silence, again three seconds alarm, two times three seconds silence, etc. Different sequences can be employed e.g. for saving battery power for longer, or the timing of the sequence may be so annoying that a person present is tempted to act. These sequences may also be adapted based on various factors such as the location of the device—dermined e.g. by means of G.P.S. or beacons, or how fast the action of a person was on previous occasions.

These and other aspects of the invention are apparent from and will be elucidated with reference to the embodiments described hereafter.

In the drawings:

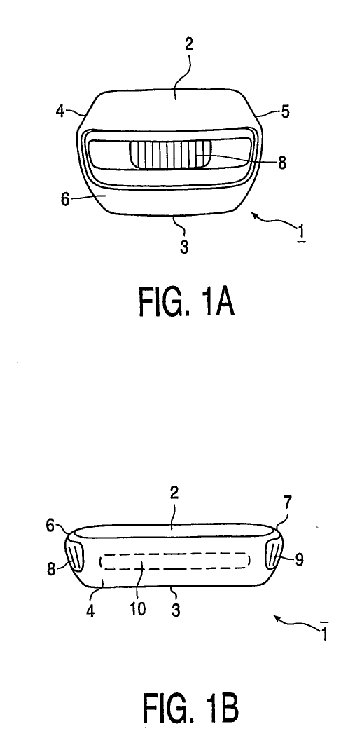

FIGS. 1A and 1B show schematically a hand-held device in accordance with the invention.

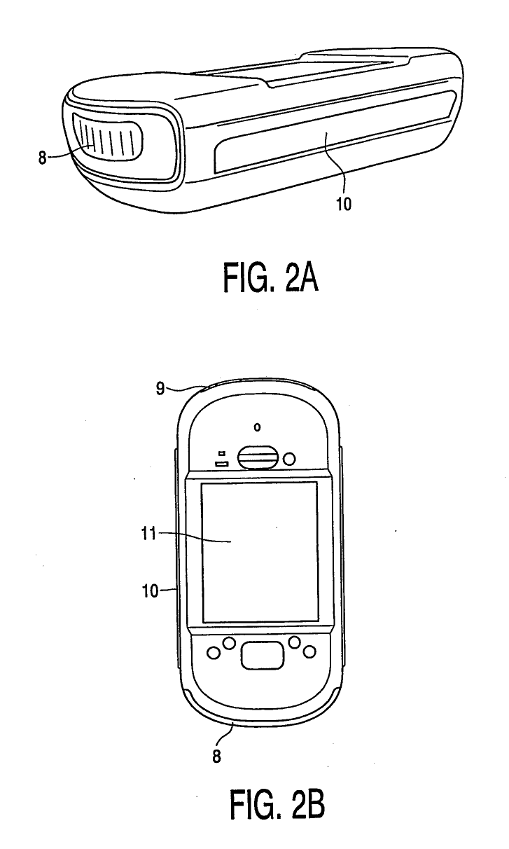

FIGS. 2A and 2B show schematically a further example of a device in accordance with the invention.

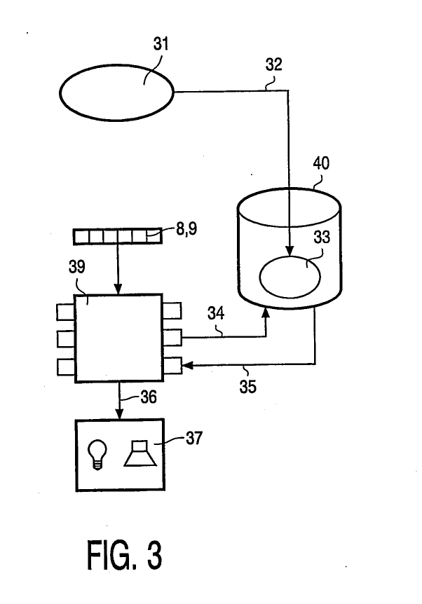

FIG. 3 shows a scheme illustrating the invention.

The figures are not drawn to scale. Generally, identical components are denoted by the same reference numerals in the figures.

FIGS. 1A and 1B show schematically an exemplary hand held device 1 in accordance with the invention. The device is shaped in a proximately elongated box with a front surface 2, a back surface 3, side surfaces 4 and 5 and a top surface 6 and a bottom surface 7. The device is provided with two oppositely arranged IR detector devices 8 and 9 for detection the presence of a person, preferably motion detectors. The IR detectors are arranged in this preferred example at the top and bottom surfaces. E.g. two passive infrared sensors of the type IRA-E700ST detecting thermal IR of about ten micron of Murata may be used, and a lens composed of facets. The lens is so constructed that when a person moves through the room different amounts of IR energy are imaged by the lens on the two sensors, hence measurement of change of these amounts indicates motion. Different motion detector systems with a different number of IR sensors and different lenses maybe employed, as they can be designed by a person skilled in the art of design of such IR motion detectors. Each motion detector—lens+sensors—has preferably a wide sensitivity angle close to 180 degrees (within approximately 140-180 degrees) By using two IR detectors mounted at the front and back surface of the device it is possible to cover a large space around the device, by using detectors with a nearly 180 degrees coverage nearly the whole space around the device can be covered. Arranging the detectors at the top and bottom surface allows space for e.g. additional touch sensors 10 at the side surfaces of the device. Provision of such touch sensors is preferred. In this example the touch sensor is comprised of a pair of thin conducting element positioned at both sides of the devices. A small potential is placed on the strips, and as soon as they are both touched with the hand, the conductive properties of the skin will cause a small current to run. Different types of sensors, such as sensors to detect the motion of the device (as would takes place when the device is picked up) may be used alternatively or additionally as touch sensor, e.g. accelerometers, pressure sensors, capacitive proximity sensors, etc.

The device has a means—e.g. a processor and memory—to store a notification, e.g. a message and/or to detect if a notification, e.g. a message, has been received. When the presence of a person is detected, the device has means (which may be in the form of a program or a part of a program code) to check whether or not an event is to be notified, e.g. whether a message to be read or heard is present (which could be done by checking a data base in which receipt of such a message is logged), and triggered by the fact that presence of a person is detected emit an alert signal (auditory and/or visual) to alert the person detected that a message or alarm is present. As stated before the type of event or notification does not form a restriction, the only feature of importance is that there is a event to be notified, whether it is a program about to start on TV, an incoming telephone, a logged message, an SMS, or whatsoever other event.

A number of preferred embodiments are also illustrated in the FIGS. 1A and 1B. The presence of a touch sensor (or own motion sensor, i.e. a sensor detecting motion of the device itself, i.e. it being picked up), the presence of the IR detectors at the top and bottom surface, the curvature of the top and bottom surface with a corresponding curvature of the window of the IR detector. The latter characteristic allows a large detection angle, without distorting too much the general shape of the device. The same characteristic would be difficult to accomplish if the IR detector would be positioned at the side surface of the device without changing the overall appearance of the device and reducing the ease of handling. The placement of the two 180 degrees motion detectors as shown in the figure is very suitable for any mobile device designed to be held by one hand in portrait position (such as mobile phones, PDAs, remote controls, E-books, etc.).

FIGS. 2A and 2B show a further example of a device in accordance with the invention wherein the same reference numerals indicate the same functional elements. This figure also shows a message or communication screen 11, e.g. an L.C.D. or electronic paper display.

The device may have means (e.g. in the form of programs or program code, or in the form of hardware) to end the alert signal after a set time period, if, upon detection of the presence of a user, the device is not picked up or activated and to reactivate the alert signal for the next time that presence of a person is detected. Said means could e.g. form a part of or be formed by program codes of a central control unit within the device. A timing device is included to provide the time.

Furthermore the device preferably comprises means to repeat the sequence of ending the alert signal and reactivation for a set number of times, followed by a non-reactive time period. The device may also have means to repeat the sequence of ending the alert signal and reactivation for a set number of times, wherein the intervals between reactivation increases. This can also reduce energy consumption.

The basic actions and parts of the device in accordance with a preferred embodiment are schematically indicated in the scheme of FIG. 3.

When a message is received (31) a signal 32 is given to store (33) the fact that there has been a message, if appropriate as well as the message itself. This can be done in any convenient data storage means 40. When the IR detectors 8, 9 detect the presence of a person (or to be more precise register a signal corresponding to the possible presence of a person) this is transferred to e.g. a central control unit 39, which then checks (34) whether or not there is message stored, and if this is confirmed (35) activates (36) means for producing an alert signal (37).

In short the invention may be described as follows:

A hand held mobile device comprises IR motion detectors. The motion detection enables to detect whether the someone is present, and to take an action, e.g. adapt the timing of presenting events to this detected presence.

The motion detection system comprises two preferably 180 degrees infrared motion detection elements placed opposite to each other to together detect movement (preferably 360 degrees) around the device. Preferably the IR detectors are placed at the top and bottom surface of the device. This configuration leaves room for other sensors, such as touch sensors, on the side of the device.

It will be appreciated by persons skilled in the art that the present invention is not limited by what has been particularly shown and described hereinabove. The invention resides in each and every novel characteristic feature and each and every combination of characteristic features, even if not explicitly recited in the claims. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

Within the concept of the invention a ‘means to repeat’ and “means to end an alert signal” is to be broadly understood and to comprise e.g. any piece of hardware (such a repetitor, ender), any circuit or sub-circuit designed for performing a repetition or ending of an alert signal as described as well as any piece of soft-ware (computer program or sub program or set of computer programs, or program code(s)) designed or programmed to perform such operations in accordance with the invention as well as any combination of pieces of hardware and software acting as such, alone or in combination, without being restricted to the below given exemplary embodiments. In general, means should be understood as software running on a processor or a dedicated circuit, e.g. on an ASIC.

The present invention has been described in terms of specific embodiments, which are illustrative of the invention and not to be construed as limiting. The invention may be implemented in hardware, firmware or software, or in a combination of them. Other embodiments are within the scope of the following claims.

1. Mobile hand-held device characterized in that the hand-held device is formed as a box, having a front and a back surface, two side surfaces, and a top and a bottom surface, and at least one surface is provided with a first infrared motion detector for detecting the presence of a person, arranged to image around the hand-held device, and means for taking an action are comprised when presence of a person is detected.

2. Mobile hand-held device as claimed in claim 1, on which a second infrared motion detector is present, the two motion detectors being positioned on the hand-held device to detect the presence of a person in substantially complementary parts of the 360 degrees around the hand-held device.

3. Mobile hand held device as claimed in claim 1, characterized in that the device comprises means for, when presence of a person is detected, checking whether or not there has been or is an event to be notified, and if so, giving an alert signal to alert the attention of the person present.

4. Mobile hand held device as claimed in claim 1, characterized in that the IR detectors are provided at the top and bottom surface of the device.

5. Mobile hand held device as claimed in claim 3, characterized in that the top and bottom surface are curved, wherein the IR detector outer windows follow the curvature.

6. Mobile hand held device as claimed in claim 1, characterized in that the device is provided with at least one touch sensor at a surface of the device.

7. Mobile hand held device as claimed in claim 1, characterized in that the device comprises means to end the alert signal after a set time period, if, upon detection of the presence of a user, the device is not picked up or activated and to reactivate the alert signal after an inactive time interval if at that time presence of a person is detected.

8. Mobile hand held device as claimed in claim 7, characterized in that the device comprises means to repeat the sequence of ending the alert signal and reactivation after the inactive time interval for a set number of times, followed by a non-reactive time period.

9. Mobile hand held device as claimed in claim 7, characterized in that the means to repeat the sequence of ending the alert signal and reactivation for a set number of times, are arranged to employ inactive time intervals of increasing duration.
